(19) United States
(12) Patent Application Publication
(10) Pub. No.: US 2019/0052793 A1
(43) Pub. Date: Feb. 14, 2019

(54) APPARATUS FOR GENERATING A SYNTHETIC 2D IMAGE WITH AN ENHANCED DEPTH OF FIELD OF AN OBJECT

(71) Applicant: KONINKLIJKE PHILIPS N.V., EINDHOVEN (NL)

(72) Inventors: JELTE PETER VINK, WAALRE (NL); BAS HULSKEN, EINDHOVEN (NL); MARTIJN WOLTERS, EINDHOVEN (NL); MARINUS BASTIAAN VAN LEEUWEN, EINDHOVEN (NL); STUART SHAND, BEST (NL)

(21) Appl. No.: 16/078,051

(22) PCT Filed: Feb. 22, 2017
(86) PCT No.: PCT/EP2017/053998

§ 371 Date: Aug. 21, 2018

(30) Foreign Application Priority Data
Feb. 22, 2016 (EP) 16156767.2

(51) Int. Cl. H04N 5/235; H04N 5/232; H04N 5/372

(52) U.S. Cl. CPC H04N 5/2356; H04N 5/23232; H04N 5/37206; H04N 5/23212

(57) ABSTRACT

The present invention relates to an apparatus for generating a synthetic 2D image with an enhanced depth of field of an object. It is described to acquire (110) with an image acquisition unit (20) first image data at a first lateral position of the object and second image data at a second lateral position of the object. The image acquisition unit is used to acquire (120) third image data at the first lateral position and fourth image data at the second lateral position, wherein the third image data is acquired at a down range distance that is different than that for the first image data and the fourth image data is acquired at a down range distance that is different than that for the second image data. First working image data is generated (130) for the first lateral position, the generation comprising processing the first image data and the third image data by a focus stacking algorithm. Second working image data is generated (140) for the second lateral position, the generation comprising processing the second image data and the fourth image data by the focus stacking algorithm. The first working image data and the second working image data are combined (150), during acquisition of image data, to generate the synthetic 2D image with an enhanced depth of field of the object.

### FIELD OF THE INVENTION

The present invention relates to an apparatus for generating a synthetic 2D image with an enhanced depth of field of an object, to a method for generating a synthetic 2D image with an enhanced depth of field of an object, as well as to a computer program element and a computer readable medium.

### BACKGROUND OF THE INVENTION

Imaging systems are limited by their depth of field, with an imaging system being arranged to have a focal point with a depth of focus centred around a feature to be imaged. However, some features that also are desired to be imaged can be closer to the imaging system than the focal plane and outside of the depth of focus and be out of focus. The same applies for features that are further away that the feature at tight focus.

### SUMMARY OF THE INVENTION

It would be advantages to have an improved technique for generating an image of an object, where the image has an enhanced depth of field.

The object of the present invention is solved with the subject matter of the independent claims, wherein further embodiments are incorporated in the dependent claims. It should be noted that the following described aspects of the invention apply also for the apparatus for generating a synthetic 2D image with an enhanced depth of field of an object, the method for generating a synthetic 2D image with an enhanced depth of field of an object, and the computer program element and the computer readable medium.

According to a first aspect, there is provided an apparatus for generating a synthetic 2D image with an enhanced depth of field of an object, the apparatus comprising:

an image acquisition unit; and

a processing unit.

The image acquisition unit is configured to acquire first image data at a first lateral position of the object and second image data at a second lateral position of the object. The image acquisition unit is also configured to acquire third image data at the first lateral position and fourth image data at the second lateral position, wherein the third image data is acquired at a down range distance that is different than that for the first image data and the fourth image data is acquired at a down range distance that is different than that for the second image data. The processing unit is configured to generate first working image data for the first lateral position, the generation comprising processing the first image data and the third image data by a focus stacking algorithm, and the processing unit is configured to generate second working image data for the second lateral position, the generation comprising processing the second image data and the fourth image data by the focus stacking algorithm to generate second working image data for the second lateral position. The processing unit is configured to combine the first working image data and the second working image data, during acquisition of image data, to generate the synthetic 2D image with an enhanced depth of field of the object.

Down range distance means a distance that is down range, or in other words that is at a distance from the apparatus or a specific part of the apparatus. Thus, objects, or parts of an object, that are at different down range distances are at different distances from the apparatus, i.e. one object or part of an object is further away from another object or another part of the object.

A discussion on focus stacking can be found on the following web page: https://en.wikipedia.org/wiki/Focus_stacking.

In this manner, a 2D image with enhanced depth of field can be acquired “on the fly”. To put this another way, the 2D image with enhanced depth of field can be acquired in streaming mode. A whole series of complete image files need not be captured and stored, and post-processed after all have been acquired, but rather the enhanced image is generated as image data is acquired.

In other words taking the down range distance to extend in a z direction, a 2D image that extends in the x and y directions can have features in focus at different x, y positions where those features are in focus over a range of down range distances z that is greater than the depth of focus of the image acquisition unit at a particular x, y position. And, this 2D image with enhanced depth of field is generated on the fly. In this particular coordinate system, z is used to denote a down range distance, with x and y then relating to coordinates perpendicular to that. This does not mean that the apparatus is limited to imaging vertically; rather “z” here can apply to a vertical, horizontal or other axis. In other words “z” is being used to denote the down range direction in order to help explain the configuration and operation of examples of the apparatus.

In this manner, imagery can be acquired on the fly without having to save intermediate images in generating an image with enhanced field of view. Furthermore, the image with enhanced field of view can be obtained as the projection of the detector of the apparatus sweeps through the object, for example either laterally or in a direction parallel to a down range axis, or even in a direction between lateral and parallel, such as obliquely. In other words, an image with enhanced depth of field can be obtained in a single pass, and without the requirement for a large image buffer.

In an example, the image acquisition unit comprises a detector configured to acquire image data of an oblique section of the object.

In this manner, by acquiring image data of an oblique section, a lateral scan (in an example the lateral scan direction is in a horizontal direction) also acquires data in the down range distance direction (e.g. in the z direction, which can also be in a vertical direction). The lateral scan can be provided when the second section is displaced horizontally or laterally from the first section in a direction perpendicular to an optical axis of the image acquisition unit. For example an imaging lens is moved in a lateral direction to laterally displace the section and/or the object is moved in a lateral direction relative to the imaging and acquisition part of the image acquisition unit to laterally displace the section. In other words, the image acquisition unit scans across the object, with a sensor that is acquiring data at different down range distances and at different lateral positions at the same time. In an example, the apparatus can be in a laboratory environment for example acquiring imagery of a fly with an enhanced depth of field and the fly is on a translation stage that moves the fly laterally with respect to the image acquisition unit. In an example, the apparatus is mounted on a system that is itself moving. For example, the apparatus is mounted on a Unmanned Aerial Vehicle (UAV) that is imaging an urban landscape, where movement of the UAV enables images at different lateral positions to be acquired. Due to the sensor acquiring an oblique section, the sensor can now acquire data at the same lateral position as for the previous acquisition but now at a different down range distance. In an example, the apparatus can form part of an industrial vision inspection system, for example for semiconductor electronics. In another example, the apparatus forms part of a panoramic camera that is rotated on a tripod, and swings through an angle (for example 360 degrees). The panoramic camera, then generates a 360 degree view of the environment with an enhanced depth of field, because the sensor acquires an oblique section with data acquired at the same lateral position at different down ranges, enabling the image to be generated on the fly that contains the best image data at each lateral position. In this manner, the image data at the same lateral position but at different down range distances can be compared to determine which image data contains the feature being in the best focus (the feature is at some down range distance in the object—here the object can be the 360 degree view of the urban landscape and a feature can be a fresco on the front of a church that is within this 360 view, for example). Then the image data with best focus at that lateral position can be used to populate a developing image with enhanced depth of field. In an example, as the sensor is scanned laterally different regions of the sensor can be activated such that a region of the sensor acquires the first image data and a different region of the sensor acquires the third image data. Therefore, as discussed “laterally” does not imply a mathematical straight line or axis, but can be a curve (as in the 360 degree panoramic sweep) or indeed can be a straight line.

In an example, the detector is a 2D detector comprising at least two active regions. In an example each active region is configured as a time delay integration (TDI) sensor. By providing a TDI detector, the signal to noise ratio can be increased.

In an example, the image acquisition unit is configured to acquire image data of a first section of the object to acquire the first image data and the second image data, and wherein the image acquisition unit is configured to acquire image data of a second section of the object to acquire the third image data and the fourth image data.

In other words, the image acquisition unit can scan through the object in a down range direction, or scan laterally through the object. In this manner, a 2D image with enhanced depth of field can be acquired “on the fly” by acquiring image data at different down range distances of the object with lateral parts of the object being imaged by the same part of a detector, or by different parts of the detector.

In an example, the image acquisition unit is configured to acquire the first image data at the first lateral position of the object and at a first down range distance and to simultaneously acquire the second image at the second lateral position of the object and at a second down range distance, wherein the first down range distance is different to the second down range distance; and wherein the image acquisition unit is configured to acquire the third image data at the first lateral position and at a third down range distance and to simultaneously acquire the fourth image data at the second lateral position and at a fourth down range distance, wherein the third down range distance is different to the fourth down range distance.

In other words the image acquisition unit is simultaneously acquiring data at different lateral positions and at different down range distances, then data at the same lateral position but at different down range distances can be compared to determine the best image data of a feature at that lateral position (i.e. that which is best in focus) that is to be used as a working image for the generation of the 2D image with enhanced depth of field. In this manner, in a single scan of the detector relative to the object in a lateral direction, image data is also acquired in the down range distance direction, and this can be used efficiently to determine an 2D image with enhanced depth of field without having to save all the image data and post process. In other words, on the fly generation of the 2D image with enhanced depth of field can progress efficiently.

In an example, the image acquisition unit has a depth of focus at the first lateral position and at the second lateral position neither of which is greater than a distance in down range distance between the down range distance at which the first image data is acquired and the down range distance at which the second image data is acquired.

In this manner, image data at different down range distances can be efficiently acquired optimally spanning a down range distance of the object that is greater than the intrinsic depth of focus of the image acquisition unit, but where image data at particular lateral positions can be processed in order to provide image data at those lateral positions that is in focus, but which is at a range of down range distances greater than depth of focus of the image acquisition unit. In this manner, different features at different down range distances can all be in focus across the 2D image having enhanced depth of field, and this enhanced image can be acquired on the fly without having to save all the image data acquired to determine the best image data.

In an example, the object is at a first position relative to an optical axis of the image acquisition unit for acquisition of the first image data and second image data and the object is at a second position relative to the optical axis for acquisition of the third image data and fourth image data.

In an example, the image data comprises a plurality of colours, and wherein the processing unit is configured to process image data by the focus stacking algorithm on the basis of image data that comprises one or more of the plurality of colours.

In a second aspect, there is provided a method for generating a synthetic 2D image with an enhanced depth of field of a object comprising:
a) acquiring with a image acquisition unit first image data at a first lateral position of the object and acquiring with the image acquisition unit second image data at a second lateral position of the object;
b) acquiring with the image acquisition unit third image data at the first lateral position and acquiring with the image acquisition unit fourth image data at the second lateral position, wherein the third image data is acquired at a down range distance that is different than that for the first image data and the fourth image data is acquired at a down range distance that is different than that for the second image data;
e) generating first working image data for the first lateral position, the generation comprising processing the first image data and the third image data by a focus stacking algorithm; and
f) generating second working image data for the second lateral position, the generation comprising processing the second image data and the fourth image data by the focus stacking algorithm; and
l) combining the first working image data and the second working image data, during acquisition of image data, to generate the synthetic 2D image with an enhanced depth of field of the object.

In an example, step a) comprises acquiring the first image data at the first lateral position of the object and at a first down range distance and simultaneously acquiring the second image at the second lateral position of the object and at a second down range distance, wherein the first down range distance is different to the second down range distance; and wherein step b) comprises acquiring the third image data at the first lateral position and at a third down range distance and simultaneously acquiring the fourth image data at the second lateral position and at a fourth down range distance, wherein the third down range distance is different to the fourth down range distance.

In an example, the method comprises:
c) calculating a first energy data for the first image data and calculating a third energy data for the third image data; and
d) calculating a second energy data for the second image data and calculating a fourth energy data for the fourth image data; and

wherein, step e) comprises selecting either the first image data or the third image data as the first working image, the selecting comprising a function of the first energy data and third energy data; and
wherein step f) comprises selecting either the second image data or the fourth image data as the second working image, the selecting comprising a function of the second energy data and fourth energy data and

wherein frequency information in image data is representative of energy data.

In this manner, the enhanced image can be efficiently generated such that at a particular lateral position it has a feature that is in best focus at that position. In other words, across the image irrespective of down range distance, features that are in best focus are selected, as a function of energy data for image data, and this can be done on the fly in a streaming mode.

In an example, the method comprises:
g) generating a first working energy data as the first energy data if the first image data is selected as the first working image or generating the first working energy data as the third energy data if the third image data is selected as the first working image; and
h) generating a second working energy data as the second energy data if the second image data is selected as the second working image or generating the second working energy data as the fourth energy data if the fourth image data is selected as the second working image is the fourth image data.

In this manner, only the already generated 2D image with enhanced depth of field need be saved (the working image) that lies behind the region already swept (or scanned) by the detector and also a working energy data file associated with the pixels of the 2D enhanced image that can be updated needs to be saved. Therefore, the storage of data is minimised, and the 2D image with enhanced depth of field can be further updated based on a comparison of the energy data now acquired with the stored energy data to update the enhanced image.

In an example, the method further comprises:
i) acquiring fifth image data at the first lateral position and acquiring sixth image data at the second lateral position, wherein the fifth image data is acquired at a down range distance that is different than that for the first and third image data and the sixth image data is acquired at a down range distance that is different than that for the second and fourth image data; and
j) generating new first working image data for the first lateral position, the generation comprising processing the fifth image data and the first working image data by the focus stacking algorithm, wherein the new first working image data becomes the first working image data; and
k) generating new second working image data for the second lateral position, the generation comprising processing the sixth image data and the second working image data by the focus stacking algorithm, wherein the new second working image data becomes the second working image data.

In other words, the working image data for a lateral position can be updated on the basis of new image data that is acquired at that lateral position, to provide the best image at that lateral position without having to save all the previous image data, and this can be achieved as the data is acquired. Once, the projection of the detector (section) has completely swept past a particular lateral position, then the image data will be formed from the best image data acquired at that lateral position and this will have been determined on the fly without each individual image data having to be saved, only the working image data needing to be saved for that lateral position.

According to another aspect, there is provided a computer program element controlling apparatus as previously described which, in the computer program element is executed by processing unit, is adapted to perform the method steps as previously described.

According to another aspect, there is provided a computer readable medium having stored computer element as previously described.

Advantageously, the benefits provided by any of the above aspects and examples equally apply to all of the other aspects and examples and vice versa.

The above aspects and examples will become apparent from and be elucidated with reference to the embodiments described hereinafter.

### BRIEF DESCRIPTION OF THE DRAWINGS

Exemplary embodiments will be described in the following with reference to the following drawings:

FIG. 1 shows a schematic set up of example of an apparatus for generating a synthetic 2D image with an enhanced depth of field of an object;

FIG. 2 shows a method for generating a synthetic 2D image with an enhanced depth of field of an object;

FIG. 3 shows an example image of focus variation in an object;

FIG. 4 shows an example image of focus variation in an object;

FIG. 5 shows schematically an example of focus stacking, with more than one image being combined into a single image;

FIG. 6 shows schematically an imaging system;

FIG. 7 shows schematically an example of an image acquisition unit used in generating a synthetic 2D image with an enhanced depth of field;

FIG. 8 shows schematically a cross section of an object, with a projection of a 2D detector array shown at two down range positions;

FIG. 9 shows schematically a cross section of an object, with a projection of a 2D detector array shown at two horizontal (lateral) positions;

FIG. 10 shows schematically a projection of a 2D detector array within an object;

FIG. 11 shows schematically a cross section of an object, with a projection of a 2D detector array shown;

FIG. 12 shows schematically an example 2D detector array;

FIG. 13 shows schematically an example of oversampling;

FIG. 14 shows schematically a number of imaged regions or layers;

FIG. 15 shows an example workflow for focus stacking.

### DETAILED DESCRIPTION OF EMBODIMENTS

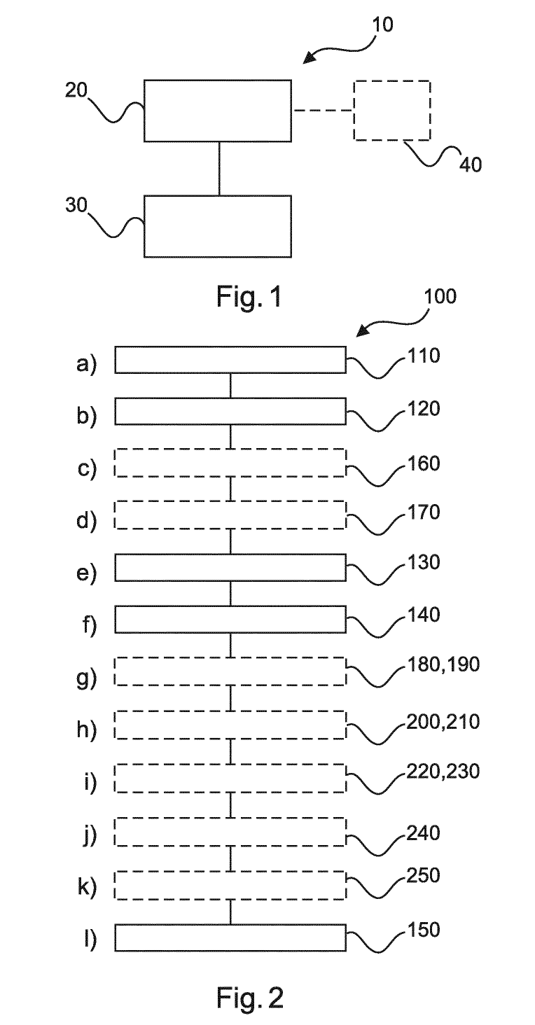

FIG. 1 shows an apparatus 10 for generating a synthetic 2D image with an enhanced depth of field of an object. The apparatus 10 comprises: an image acquisition unit 20 and a processing unit 30. The image acquisition unit 20 is configured to acquire first image data at a first lateral position of the object and second image data at a second lateral position of the object. The image acquisition unit 20 is also configured to acquire third image data at the first lateral position and fourth image data at the second lateral position. The third image data is acquired at a down range distance that is different than that for the first image data and the fourth image data is acquired at a down range distance that is different than that for the second image data. The processing unit 30 is configured to generate first working image data for the first lateral position, the generation comprising processing the first image data and the third image data by a focus stacking algorithm. The processing unit 30 is also configured to generate second working image data for the second lateral position, the generation comprising processing the second image data and the fourth image data by the focus stacking algorithm to generate second working image data for the second lateral position. The processing unit 30 is configured to combine the first working image data and the second working image data, during acquisition of image data, to generate the synthetic 2D image with an enhanced depth of field of the object.

In an example, the image acquisition unit is a camera. In an example, the apparatus is a camera. In other words, a camera can be a self-contained unit that is generating images with an enhanced field of view. Or, a camera can acquire imagery that is passed to an external processing unit that is then generating the images with an enhanced field of view. Here, the direction “down range” is parallel to an optical axis of the image acquisition unit. In other words, the down range direction is in the direction that the image acquisition unit is imaging. To put this another way, if an object is moved directly away from the image acquisition unit by a distance H, such that its centre does not move laterally within the field of view of the image acquisition unit, then the object has moved down range by a distance H. The lateral direction is then perpendicular to the down range direction.

It is to be noted that “down range distance” does not imply a particular distance scale. For example, the apparatus can be used to generate a synthetic image with enhanced depth of field of an ant or fly, where down range distances, and/or differences in down range distances, can be of the order of fractions of millimetres, millimetres, or centimetres. Also, the apparatus can be used to generate a synthetic image with enhanced depth of field of a flower or an image of a living room, where down range distances, and/or differences in down range distances, can be of the order of micrometres, millimetres, centimetres, and metres. Also, the apparatus can be used to generate a synthetic image with enhanced field of view of an urban landscape or pastoral landscape. For example, the apparatus can be mounted on an aeroplane or UAV, that points downwards and generates a synthetic image with enhanced depth of field of a city, where the rooftops of sky scrapers are in focus as well as the objects at ground level. In such an example, the down range distance, and/or differences in down range distances, can be of the order of centimetres, metres, and tens to hundreds of metres. In an example, the apparatus can be mounted on a submersible rov, where imagery of the sea bed for example is being imaged. In another example, the apparatus can be mounted on a satellite that is for example orbiting an extraterrestrial moon, and imaging the surface as it flies by. In such an example, the down range distance, and/or differences in down range distances, can be of the order of centimetres, metres, hundreds of metres to kilometres. In an example, the down range distance is in a direction that is substantially parallel to an optical axis of the image acquisition unit.

In an example, the image acquisition unit has a depth of focus at the first lateral position that is not greater than a distance in range between the down range distance at which the first image data is acquired and the down range distance at which the third image data is acquired.

In an example, a movement from the first lateral position to the second lateral position is substantially parallel to a scan direction of the apparatus. Here scan direction can mean movement of the apparatus relative to the object, due to movement of the apparatus and/or movement of the object and/or movement of parts of the apparatus. In other words, the projection of the detector can be swept laterally for example due to a lateral movement of the object, which could for example be an ant or fly on a translation stage, with the translation stage being moveable in the x, y, and also in z directions. Or, this could be due to movement of the apparatus, for example the apparatus can be on a UAV with the apparatus imaging in a direction perpendicular to the flight direction (for example the down range direction can be vertically downwards) and the projection of the detector can be swept due to the forward motion of the UAV. Or this could be to movement of a lens or lenses within the image acquisition unit along with appropriate movement of the detector if necessary such the projection of the detector is swept laterally through an object as the lenses/detector are moved.

In an example, the image acquisition unit comprises a detector 40 configured to acquire image data of a section of the object that is substantially perpendicular to the down range direction, i.e. perpendicular to an optical axis of the image acquisition unit.

According to an example, the image acquisition unit comprises a detector 40 configured to acquire image data of an oblique section of the object.

In an example, the regions of the sensor are activated using information derived from an autofocus sensor, for example as described in WO2011/161594A1 with respect to a microscope system, but with applicability to the present apparatus. In other words, a feature can be tracked in down range distance by enabling appropriate regions of the sensor to be activated in order to acquire that feature at an appropriately good degree of focus to form part of an image with enhanced depth of field as that feature changes in down range distance within the object.

In an example, the second section is displaced both in a down range direction (e.g. vertically or z direction) and in a lateral direction (e.g. horizontally or x, or y direction) from the first section. In an example, an imaging lens is moved in a in a down range direction (e.g. vertical direction) and moved in a lateral direction to displace the section. In an example, the object is moved in a in a down range direction (e.g. vertical direction) and moved in a lateral direction relative to the imaging and acquisition part of the image acquisition unit to displace the section. In an example, an imaging lens is moved in a in a down range direction (e.g. vertical direction) and the object is moved in a lateral direction relative to the imaging and acquisition part of the image acquisition unit to displace the section. In an example, an imaging lens is moved in a lateral direction and the object is moved in a in a down range direction (e.g. vertical direction) relative to the imaging and acquisition part of the image acquisition unit to displace the section. In an example, before acquiring the image with enhanced depth of focus, the object is imaged to estimate the position of a feature or features as a function of down range distance at different lateral (x, y) positions across the object. Then, when the object is scanned to generate the image with enhanced depth of focus the imaging lens can be moved in a down range direction (e.g. vertically) at different lateral positions and/or the object can be moved in a down range direction (e.g. in a vertical direction) such that the same regions of the sensor can be activated to follow a feature as it changes down range distance within a object in order to acquire that feature at an appropriately good degree of focus to form part of an image with enhanced depth of field as that feature changes in down range distance within the object.

In an example the detector is tilted to provide the oblique section. In an example, the detector is tilted with respect to an optical axis of the microscope scanner. In other words, in a normal “non-tilted” microscope configuration, radiation from the object that is imaged onto a detector such that the radiation interacts with the detector in a direction substantially normal to the detector surface. However, with the detector tilted to provide an oblique section, the radiation interacts with the detector in a direction that is not normal to the detector surface.

In an example, the oblique section is obtained optically, for example through the use of a prism.

In an example, the first image data and the third image data are acquired by different parts of the detector, and wherein the second image data and the fourth image data are acquired by different parts of the detector.

According to an example, the detector 40 is a 2D detector comprising at least two active regions.

In an example, each of the active regions is configured as a time delay integration (TDI) sensor.

In an example, the detector is a 2D CCD detector, for example a detector as typically used in digital cameras. In other words, the apparatus can make use of a standard detector but used in a different manner, which can involve it being configured to acquire image data an oblique section of the object, to obtain an image with an enhanced depth of field on the fly.

In an example, the detector has at least four active regions. In other words, as the projection of the detector at the object is moved laterally it could be moved in a down range direction (e.g. vertically) too in which case two active regions could acquire the first, second, third and fourth image data. However, as the projection of the detector is moved laterally it could remain at the same down range position (e.g. vertical position) in which case four active regions could acquire the first, second, third and fourth image data.

By providing a TDI detector, the signal to noise ratio can be increased.

In an example, the detector is configured to provide at least two line images, and wherein the first image data is formed from a subset of a first one of the line images and the second image data is formed from a subset of a second one of the line images.

In an example, an active region is configured to acquire a line of image data at substantially the same down range distance within the object.

In other words, the 2D detector acquires a cross section of the object, acquiring imagery over a range of x, y coordinates. At a number of x coordinates the detector has a number of line sensors that extend in the y direction. If the detector is acquiring an oblique cross section, then each of these line sensors also acquires data at different z coordinates (down range distances), where each line image can acquire image data at the same down range distance for example if the section is only tilted about one axis. If imagery along the length of the line sensor was utilised, a smeared image would result, therefore a section of the line image is utilised. However, in an example the image data along the line sensor is summed, which is subsequently filtered with a band filter—for details see U.S. Pat. No. 4,141,032A.

In an example, all sections along the line section are utilised. In this manner, at every x, y position the image data that is in best focus at a particular z position (down range distance) can be selected to populate the streamed 2D enhanced image with enhanced depth of focus that is being generated.

In an example, the detector comprises three or more active regions, each configured to acquire image data at a different down range distance in the object, wherein the down range distance at which one active region images a part of the object is different to the down range distance at which an adjacent active region images a part of the object, where this difference in down range distance is at least equal to a depth of focus of the image acquisition unit. In other words, as the detector is scanned laterally each of the active areas sweeps out a “layer” within which features will be in focus as this layer has a range of down range distance or thickness equal to the depth of focus of the image acquisition unit and the active region acquires data of this layer. For example, 8 layers could be swept out across the object, the 8 layers then extending in down range distance by a distance at least equal to 8 times the depth of focus of the detector. In other words, as the detector begins to scan laterally, for the simple case where the detector does not also scan in a down range direction (e.g. vertically), then at a particular lateral (e.g. x) position initially two images acquired by active areas 1 and 2 (with the section of the detector having moved laterally between image acquisitions) at different but adjacent down range distances are compared, with the best image from 1 or 2 forming the working image. To recall, the down range distances being imaged by active areas 1 and 2 are separated by a distance at least equal to the intrinsic depth of focus of the image acquisition unit and therefore cannot in one image at the same lateral position be in focus at the same time. The section of the detector moves laterally, and now the image acquired by active area 3 at position x and at an adjacent but different down range distance to that for image 2 is compared to the working image and the working image either remains as it is, or becomes image 3 if image 3 is in better focus that the working image (thus the working image can now be any one of images 1, 2, or 3). The section of the detector again moves laterally, and the image acquired by active area 4 at position x, but again at a different adjacent down range distance is compared to the working image. Thus after the image acquired by the eighth active region is compared to the working image, and the working image either becomes the eighth image data or stays as the working image, then at position x, whichever of images 1-8 that was in best focus forms the working image, which is now in focus. In the above, the active areas could be separated by more than the depth of focus of the image acquisition unit and/or there could be many more than 8 active regions. In this manner, a feature can be imaged in one scan of the detector where the down range distance of that feature in the object varies by more than the intrinsic depth of focus of the image acquisition unit (i.e., at one moment in time at one lateral position), and where a 2D image with enhanced depth of focus is provided without having to save each of the “layer” images, rather only saving a working image and comparing this to image data now being acquired, such that the enhanced image is acquired on the fly. In an example, the apparatus comprises an autofocus system whereby the section (the projection of the detector at the object) moves in a down range (z) direction (e.g. vertically) as well as laterally (e.g. horizontally), in order for example to follow a object that is itself varying in the z direction—for example the apparatus is in a plane or UAV flying over a city and generating imagery where features at the road level and at the top of skyscrapers are both in focus, but where the UAV flies at a constant altitude above sea level but where the city is very hilly.

In an example, the image acquisition unit is configured such that the oblique section is formed such that the section is tilted in the lateral direction, for example in the scan direction. In other words, each line sensor of the detector when it forms one section is at a different x position and at a different down range distance z, but extends over substantially the same range of y coordinates. To put this another way, each line sensor is substantially perpendicular to the lateral direction of the scan and in this manner a greatest volume can be swept out in each scan of the detector relative to the object.

According to an example, the image acquisition unit is configured to acquire image data of a first section of the object to acquire the first image data and the second image data. The image acquisition unit is also configured to acquire image data of a second section of the object to acquire the third image data and the fourth image data.

In an example, the second section is displaced in a down range direction (e.g. vertically) from the first section in a direction parallel to an optical axis of the image acquisition unit. In an example, an imaging lens is moved in a down range direction (e.g.

vertical direction) to displace the section in a down range direction (e.g. vertically). In an example, the object is moved in a down range direction (e.g. in a vertical direction) relative to the imaging and acquisition part of the image acquisition unit to displace the section in a down range direction (e.g. vertically). For example, the apparatus could be part of a camera system mounted on the front of a car, and imaging in a forward direction. The camera system would have an intrinsic depth of field that is much less than the depth of field in an enhanced imaged that is being presented for example on a Head Up Display for the driver in an updated fashion. Furthermore, such an enhanced image could be provided to a processing unit in the car, that for example is using image processing to enable warnings to be provided to the driver.

In an example, the second section is displaced horizontally or laterally from the first section in a direction perpendicular to an optical axis of the image acquisition unit. In an example, an imaging lens is moved in a lateral direction to laterally displace the section. In an example, the object is moved in a lateral direction relative to the imaging and acquisition part of the image acquisition unit to laterally displace the section.

According to an example, the image acquisition unit is configured to acquire the first image data at the first lateral position of the object and at a first down range distance and to simultaneously acquire the second image at the second lateral position of the object and at a second down range distance. The first down range distance is different to the second down range distance. The image acquisition unit is also configured to acquire the third image data at the first lateral position and at a third down range distance and to simultaneously acquire the fourth image data at the second lateral position and at a fourth down range distance. The third down range distance is different to the fourth down range distance.

According to an example, the image acquisition unit has a depth of focus at the first lateral position and at the second lateral position neither of which is greater than a distance in down range distance between the down range distance at which the first image data is acquired and the down range distance at which the second image data is acquired.

According to an example, the object is at a first position relative to an optical axis of the image acquisition unit for acquisition of the first image data and second image data and the object is at a second position relative to the optical axis for acquisition of the third image data and fourth image data.

In an example, the object is configured to be moved in a lateral direction with respect to (in an example relative to) the optical axis, wherein the object is at a first position for acquisition of the first and second image data and the object is at a second position for acquisition of the third and fourth image data.

According to an example, the image data comprises a plurality of colours, and wherein the processing unit is configured to process image data by the focus stacking algorithm on the basis of image data that comprises one or more of the plurality of colours.

In an example, the plurality of colours can be Red, Green, and Blue. In an example, the processing unit is configured to process image data that corresponds to a specific colour—for example an object being imaged may have a characteristic colour and processing the image with respect to a specific colour or colours can provide imaging advantages as would be appreciated by the skilled person, for example improving contrast. In this manner, a specific feature can be acquired with enhanced depth of field. In another example, different colour channels can be merged, for example using a RGB2Y operation. In this manner, signal to noise can be increased. Also, by applying a colour separation step, different, and most optimised, 2D smoothing kernels can be utilised.

In an example, the first working image data is either the first image data or the third image data, and wherein the second working image data is either the second image data or the fourth image data.

In other words, the best focal position of a specific feature is acquired and this is used to populate the streamed enhanced image that is being generated.

In an example, the processing unit is configured to calculate a first energy data for the first image data and calculate a third energy data for the third image data and generating the first working image comprises selecting either the first image data or the third image data as a function of the first energy data and third energy data, and wherein the processing unit is configured to calculate a second energy data for the second image data and calculate a fourth energy data for the fourth image data and generating the second working image comprises selecting either the second image data or the fourth image data as a function of the second energy data and fourth energy data.

In an example, a high pass filter is used to calculate the energy data. In an example, the high pass filter is a Laplacian filter. In this way, at each lateral position features that are in best focus at a particular down range distance can be selected and used in the 2D image with enhanced depth of field.

In an example, after filtering a smoothing operation is applied. In this manner noise can be reduced.

In an example, rather than applying a Laplacian filter the acquired data are translated to the wavelet domain, where the high frequency sub band can be used as a representation of the energy. This can be combined with the iSyntax compression (see for example U.S. Pat. No. 6,711,297B1 or U.S. Pat. No. 6,553,141).

In an example, rather than selecting either the first image data or the third image data, the first image data and third image data are combined using a particular weighting based on the distribution of energy of the first image data and the third image data.

In an example, the processing unit is configured to generate a first working energy data as the first energy data if the first image data is selected as the first working image or generate the first working energy data as the third energy data if the third image data is selected as the first working image, and wherein the processing unit is configured to generate a second working energy data as the second energy data if the second image data is selected as the second working image or generate the second working energy data as the fourth energy data if the fourth image data is selected as the second working image is the fourth image data.

In an example, the image acquisition unit is configured to acquire fifth image data at the first lateral position and sixth image data at the second lateral position, wherein the fifth image data is acquired at a down range distance that is different than that for the first and third image data and the sixth image data is acquired at a down range distance that is different than that for the second and fourth image data; and wherein the processing unit is configured to generate new first working image data for the first lateral position, the generation comprising processing the fifth image data and the first working image data by the focus stacking algorithm, wherein the new first working image data becomes the first working image data; and the processing unit is configured to generate new second working image data for the second lateral position, the generation comprising processing the sixth image data and the second working image data by the focus stacking algorithm, wherein the new second working image data becomes the second working image data.

In an example, the processing unit is configured to calculate a fifth energy data for the fifth image data and calculate a sixth energy data for the sixth image data; and wherein the processing unit is configured to generate new first working energy data as the fifth energy data if the first working image is selected as the fifth working image or generate new first working energy data as the existing first working energy data if the first working image is selected as the existing first working image; and wherein the processing unit is configured to generate new second working energy data as the sixth energy data if the second working image is selected as the sixth working image or generate new second working energy data as the existing second working energy data if the second working image is selected as the existing second working image.

In an example, a measure of the sum of the energy at a particular lateral position (i.e., at an x coordinate) is determined. In this manner, a depth range within the object can be determined as this is related to the energy in each image (e.g, related to the energy in each layer).

FIG. 2 shows a method 100 for generating a synthetic 2D image with an enhanced depth of field of an object in its basic steps. The method comprises the following:

In an acquiring step 110, also referred to as step a), an image acquisition unit 20 is used to acquire first image data at a first lateral position of the object and is used to acquire second image data at a second lateral position of the object.

In an acquiring step 120, also referred to as step b), the image acquisition unit is used to acquire third image data at the first lateral position and is used to acquire fourth image data at the second lateral position, wherein the third image data is acquired at a down range distance that is different than that for the first image data and the fourth image data is acquired at a down range distance that is different than that for the second image data.

In a generating step 130, also referred to as e), first working image data is generated for the first lateral position, the generation comprising processing the first image data and the third image data by a focus stacking algorithm.

In a generating step 140, also referred to as f), second working image data is generated for the second lateral position, the generation comprising processing the second image data and the fourth image data by the focus stacking algorithm.

In a combining step 150, also referred to as step l), the first working image data and the second working image data are combined, during acquisition of image data, to generate the synthetic 2D image with an enhanced depth of field of the object.

In an example, the image acquisition unit is configured to acquire image data of a first section of the object to acquire the first image data and the second image data, and wherein the image acquisition unit is configured to acquire image data of a second section of the object to acquire the third image data and the fourth image data.

In an example, the image acquisition unit comprises a detector configured to acquire image data of an oblique section of the object.

In an example, the detector is a 2D detector comprising at least two active regions. In an example, each is configured as a time delay integration (TDI) sensor.

According to an example, step a) comprises acquiring the first image data at the first lateral position of the object and at a first down range distance and simultaneously acquiring the second image at the second lateral position of the object and at a second down range distance, wherein the first down range distance is different to the second down range distance; and wherein step b) comprises acquiring the third image data at the first lateral position and at a third down range distance and simultaneously acquiring the fourth image data at the second lateral position and at a fourth down range distance, wherein the third down range distance is different to the fourth down range distance.

In an example, the object is at a first position relative to an optical axis of the image acquisition unit for acquisition of the first image data and second image data and the object is at a second position relative to the optical axis for acquisition of the third image data and fourth image data.

In an example, the object is configured to be moved in a lateral direction with respect to the optical axis, wherein the object is at a first position for acquisition of the first and second image data and the object is at a second position for acquisition of the third and fourth image data.

In an example, the image data comprises a plurality of colours, and wherein the processing unit is configured to process image data by the focus stacking algorithm on the basis of image data that comprises one or more of the plurality of colours.

In an example, the first working image data is either the first image data or the third image data, and wherein the second working image data is either the second image data or the fourth image data.

According to an example, the method comprises:

In a calculating step 160, also referred to as step c), a first energy data for the first image data is calculated and a third energy data for the third image data is calculated.

In a calculating step 170, also referred to as step d), a second energy data for the second image data is calculated and a fourth energy data for the fourth image data is calculated; and

wherein, step e) comprises selecting either the first image data or the third image data as the first working image, the selecting comprising a function of the first energy data and third energy data; and wherein step f) comprises selecting either the second image data or the fourth image data as the second working image, the selecting comprising a function of the second energy data and fourth energy data. To recall, this selection can be at a local (pixel or few pixel) level rather than for the complete line of pixels, in other words at a level relating to parts of the line of pixels.

According to an example, the method comprises:

In a generating step, also referred to as step g), a first working energy data is generated 180 as the first energy data if the first image data is selected as the first working image or the first working energy data is generated 190 as the third energy data if the third image data is selected as the first working image; and

In a generating step, also referred to as step h), a second working energy data is generated 200 as the second energy data if the second image data is selected as the second working image or the second working energy data is generated 210 as the fourth energy data if the fourth image data is selected as the second working image is the fourth image data.

To recall, the detector can be acquiring line image data, such that a first image is a subset of that line image data etc, with selection able to proceed at a local (pixel) level, such that images can be combined to create a new working image having features in focus coming each of the input images.

According to an example, the method comprises:

In an acquiring step, also referred to as step i), fifth image data is acquired 220 at the first lateral position and sixth image data is acquired 230 at the second lateral position, wherein the fifth image data is acquired at a down range distance that is different than that for the first and third image data and the sixth image data is acquired at a down range distance that is different than that for the second and fourth image data.

In a generating step 240, also referred to as step j), new first working image data is generated for the first lateral position, the generation comprising processing the fifth image data and the first working image data by the focus stacking algorithm, wherein the new first working image data becomes the first working image data.

In a generating step 250, also referred to as step k), new second working image data is generated for the second lateral position, the generation comprising processing the sixth image data and the second working image data by the focus stacking algorithm, wherein the new second working image data becomes the second working image data.

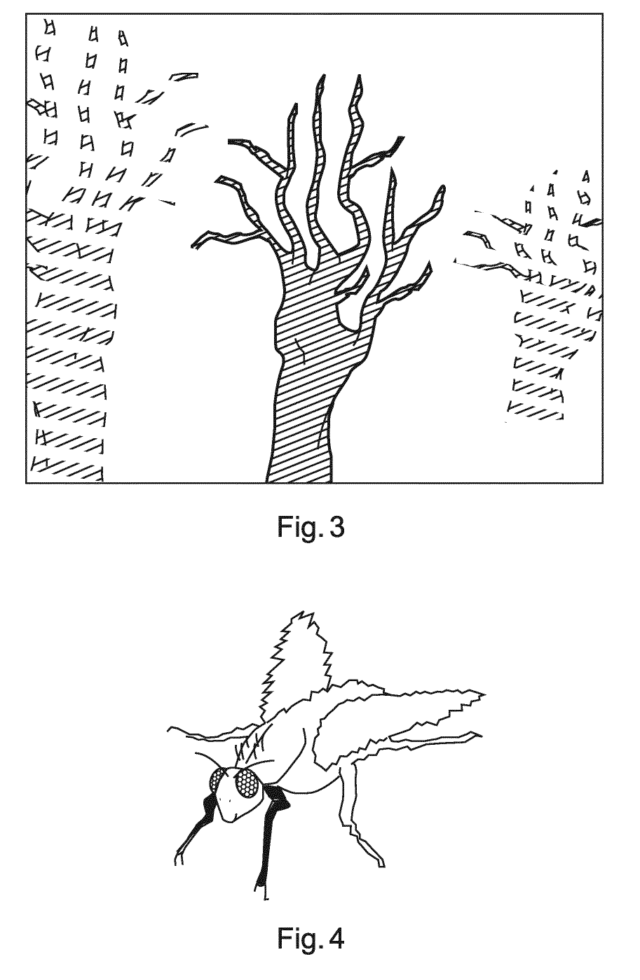

The apparatus and method for generating a synthetic 2D image with enhanced depth of field of an object will now be described in more detail with reference to FIGS. 3-15.

FIGS. 3 and 4 help to show an issue addressed by the apparatus and method for generating a synthetic 2D image with enhanced depth of field of an object. In FIG. 3 the object is a woodland scene, with three trees in the field of view. The tree on the left is close to the imaging system, the tree on the right is far from the imaging system and the tree in the centre is at a distance between the two. The imaging system has a depth of field within which objects can be in focus, however all three trees extend over a down range that is greater than the depth of focus of the imaging system. Consequently, with the centre tree in focus, the trees either side are out of focus. A similar situation is shown in FIG. 4. Here the object is a fly. The imaging system has a depth of field that extends over a down range that is smaller than the depth of the fly in the down range direction. Therefore, when the front part of the fly is in focus the rear part of the fly, that is further away from the imaging system than the front part of the fly, is out of focus. This is shown in FIG. 4.

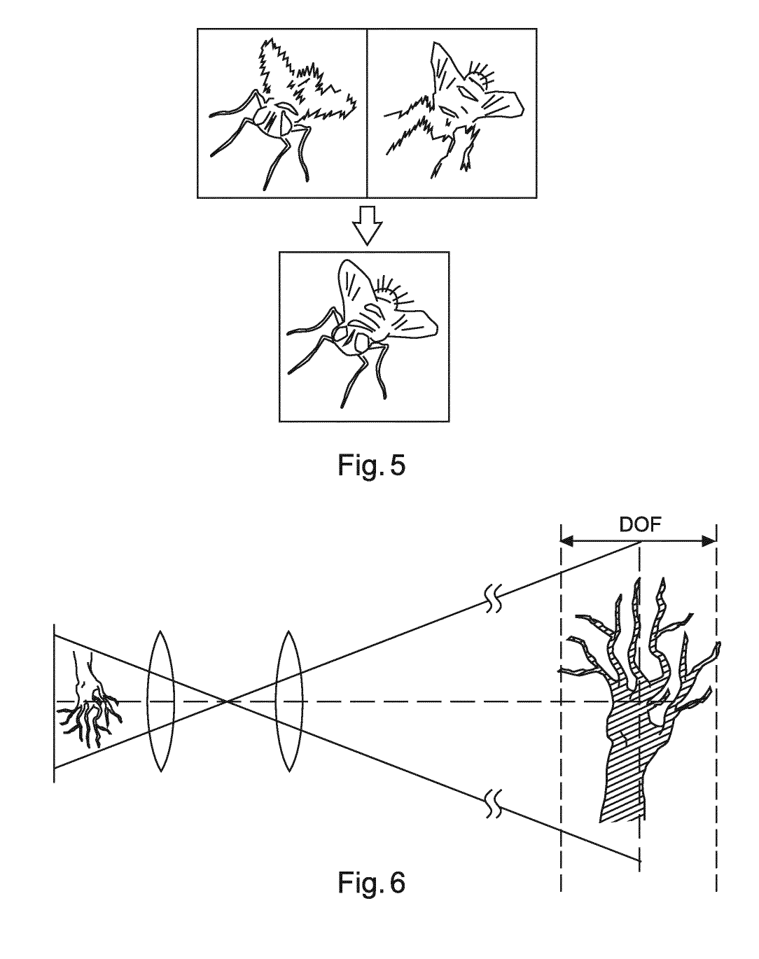

FIG. 5 schematically shows an example of a focus stacking technique. An imaging system is being used to acquire images of a fly, which has a depth greater than the depth of focus of the imaging system. A number of digital images are acquired at different focal positions, such that different parts of the fly are in focus in different images. In one image a front part of the fly is in focus, whilst a rear part of the fly is out of focus. In another image, the front part of the fly is out of focus, whilst the rear part of the fly is in focus. In other words, a 3D stack of images is acquired with each image being a 2D image at a particular focal depth. After the images are acquired, they can be compared to determine which parts of the fly are in focus in which image. Then a composite image is generated from the in-focus parts of the fly from the differing images. However, all the images at the different focal depths have to be stored, which requires a very large image buffer, and an enhanced image is only determined after all the images have been acquired, and each image only relates to one depth.

FIG. 6 shows an imaging system imaging an object, such as a tree. An image of the tree is projected onto the detector of the imaging system. However, the imaging system has a depth of field that is less than the depth of the tree. Therefore, any particular region in depth of the tree can be imaged in focus on detector with the areas of the tree in front of and behind that depth of field then being out of focus. Here, one can imagine a tree in winter with the branches at the front and back of the tree being visible to a viewer placed at the front.

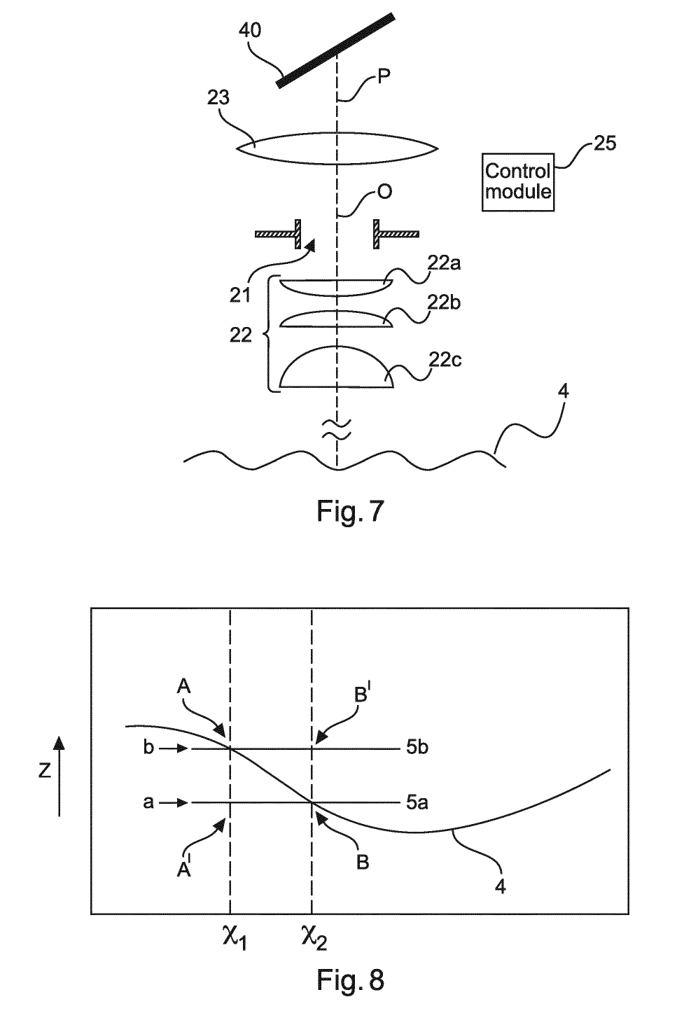

The apparatus and method for generating a synthetic 2D image with enhanced depth of field of an object, addresses the above issues by providing a streaming focus stacking technique that can be applied to convert image data into an artificial (synthetic) 2D image with enhanced depth of field as the data is being acquired. This is done “on the fly” without intermediate image files having to be saved, obviating the need for very large image buffers. In an example, image data is acquired from multiple down range positions simultaneously. Here, down range is considered for explanatory purposes to extend in a z or depth direction, but could extend in any direction (horizontal or vertical or there between). The apparatus and method for generating a synthetic 2D image with enhanced depth of field of an object is specifically discussed with reference to FIGS. 7-15.

FIG. 7 shows schematically an example of an image acquisition unit that is used to generate a synthetic 2-D image with enhanced depth of field of an object 4. The object has features that extend over a number of down range distances, with some features being at a larger down range distance than others. In other words, some parts or features of the object 4 are closer to the image acquisition unit than others. This image acquisition unit is arranged for imaging the object 4. Object 4 could be a static scene, where the image acquisition unit moves relative to the scene such as an urban environment imaged by the apparatus mounted on a UAV, or the object can be an object such as a fly that is positioned on a translation table that is able to translate the table laterally with respect to the image acquisition unit that could be provided in a teaching environment. Along an imaging path P and starting from the object 4, the image acquisition unit comprises a first imaging lens 22, typically made of a plurality of lenses 22 a, b and c, an aperture 21 for blocking radiation. The image acquisition unit also comprises a second imaging lens 23 and a sensor in the form of a 2-D detector array 40. The detector is tilted with respect to the optical axis O of the first imaging lens and this forms an oblique projection (section) of the detector in the object. Such an oblique section could also be formed optically, through for example the use of a prism rather than having the detector tilted to the optical axis. In another example, the detector being configured to acquire image data of an oblique section of the biological sample is achieved for the case where the optical axis O of the microscope objective is parallel to a normal to the detector surface. Rather, the sample stage itself is tilted with respect to the optical axis O and the sample is scanning parallel to the tilted angle of the sampleln an example, the image acquisition unit forms part of an apparatus 10 for generating a synthetic image with an enhanced depth of field. The apparatus 10 comprises a control module 25, which can be part of a processor 30, controlling the operating process of the apparatus and the scanning process for imaging the object, for example moving the translation table and acquiring and processing imagery from the detector. Light striking the object 4 is scattered and is captured by the imaging lens 22, and imaged by the lens 23 on to the 2-D detector array 40. It is to be noted that “tilted” with respect to the optical axis means that the radiation from the object which impinges on the detector does not impinge perpendicularly (as discussed this can be achieved through tilting of the sensor itself, or optically for a non-tilted sensor).

FIG. 8 serves to help explain one example of the apparatus and method for generating a synthetic image with an enhanced depth of field of an object. FIG. 8 schematically shows an object 4, that extends laterally across a field of view. The object varies in down range distance across the field of view over a distance that is greater than the depth of focus of the apparatus at positions across the projection (section 5—shown as two sections 5a and 5b acquired at different times) of the detector in the object. At a lateral position x1 the object 4 has feature A that is to be imaged. At a lateral position x2 the object 4 has feature B that is to be imaged. Features A and B could be the same type of material, such that they reflect radiation over similar wavelength bands or could be dissimilar in that they reflect differently. The apparatus 10 could be operating with light transmitting through the object and/or light reflecting from the object as would be appreciated by the skilled person. The apparatus 10 is configured such that image data is acquired of a section 5a of the object. In other words, the projection of the detector of the apparatus is located at position (a) shown in FIG. 8. The apparatus has a depth of focus such that features within a small distance either side of the section 5a are in focus. Therefore, in a first image acquired of the section 5a, the tissue layer 4 is out of focus at position xl, with the out of focus feature termed A′. However, in the first image acquired of the section 5a, the tissue layer 4 is in focus at position x2, with the in focus feature termed B. The acquired image becomes a working image. The imaging lens 22 is then moved, such that the section 5 over which data are required has moved to a new down range position 5b in the object. Rather than move the imaging lens 22, the object itself could be moved in a down range direction (parallel to the optical axis O as shown in FIG. 7 or the apparatus moved in a down range direction). In this second image, at position xl feature A is now in focus, whilst feature B is out of focus B′. A processing unit, not shown, then updates the working image such that the image data at position xl is changed from that acquired in the first image to that acquired in the second image (A′ becomes A), whilst the image data at position x2 is not changed. This can be carried out at a number of positions along the detector, and for a number of down range positions through the object. The working image is then at all lateral positions (x) continuously updated with the most in focus feature at that lateral position on the fly. Only the working image needs to be saved and compared with the image that has just been acquired, and all the previously acquired images need not be saved. In this manner, the working image contains features that are in focus but that are also at depths greater than the intrinsic depth of focus of the apparatus. Having progressed through the object in a down range direction the whole object itself can be translated laterally and the operation repeated for a part of the object has not yet been imaged. Accordingly, an on-the-fly image is created having enhanced depth of focus while the object is scanned, which enables saving a large amount of data. In the example shown in FIG. 8, the projection of the detector at the object (section 5) is shown perpendicularly to the optical axis O, however it is apparent that this described streaming technique for generating an image with an enhanced depth of field can operate if the projection of the detector in the object is such that section 5 is oblique, i.e., not perpendicular to the optical axis O.

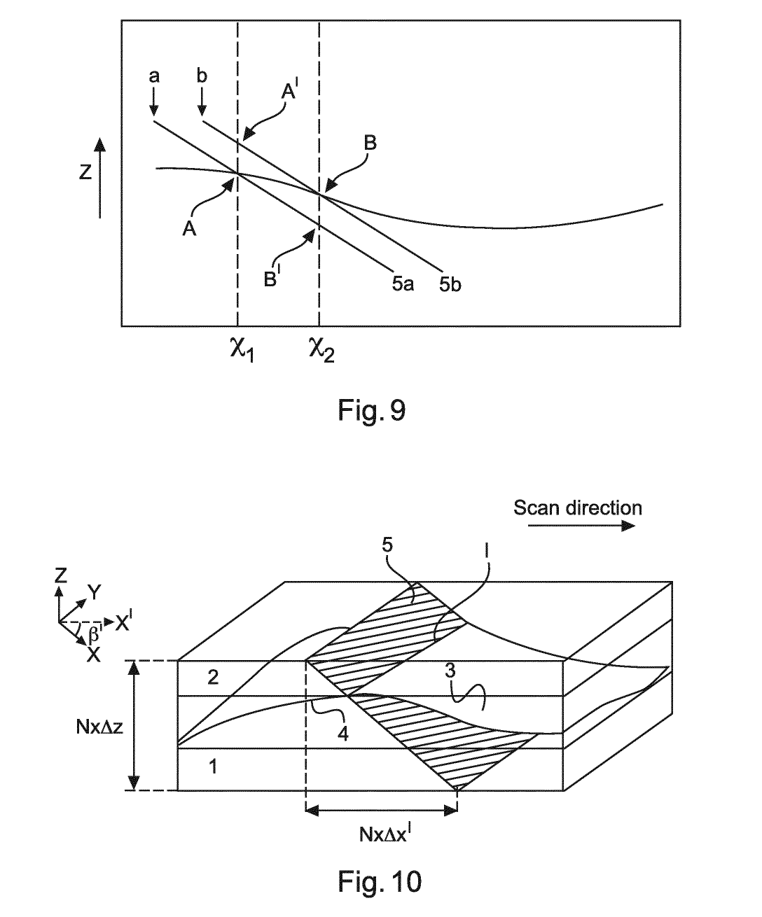

FIG. 9 serves to help explain another example of the apparatus and method for generating a synthetic image with an enhanced depth of field of an object. FIG. 9 schematically shows the object 4, as was shown in FIG. 8. Again, the object varies in down range distance across the field of view over a distance that is greater than the depth of focus of the apparatus at positions across the projection (section 5- shown as two sections 5a and 5b acquired at different times) of the detector in the object. At a lateral position xl the object 4 has feature A that is to be imaged. Now, the apparatus comprises a detector configured to acquire image data of oblique section (5a, 5b) of the object. As discussed above, this can be achieved through tilting of the detector or optically. In a first image acquired (a) of the section 5a the tissue layer 4 is in focus at position xl, with this termed feature A. However, in the first image of section 5a the tissue layer 4 is out of focus at position x2, with this termed feature B′. As for the example described with respect to FIG. 8, the acquired image becomes a working image. The apparatus is then configured to move the projection of the detector (section 5) such that oblique section 5a moves laterally and is shown as oblique section 5b. A translation stage moves laterally in order that image data of an oblique section is acquired at different lateral positions within the object. However, movement of the lenses and/or the detector could affect this movement of the oblique section as would be understood by the skilled person. At the new position, termed (b) the detector again acquires data at position xl and at position x2, however different parts of the detector are now acquiring this data for the situation where the oblique section has only moved laterally. In the second image, at position xl the tissue layer 4 is now out of focus, with the acquired image termed A′, whilst the tissue layer 4 at position x2 is in focus, with this termed feature B. A processing unit, not shown, then updates the working image such that the image data at position xl remains as it is whilst the image data at position x2 is changed to that acquired in the second image (B′ becomes B). This can be carried out at a number of positions along the detector, each equating with a different down range position through the object. As the oblique section 5 is scanned laterally through the object the working image is then at all lateral positions (x) continuously updated with the most in focus feature at that lateral position on the fly. Only the working image needs to be saved and compared with the image that has just been acquired, and all the previously acquired images need not be saved. In this manner, the working image contains features that are in focus but that are also at depths greater than the intrinsic depth of focus of the apparatus. Having progressed laterally through the object the whole object itself can be translated laterally, perpendicularly to the previous scan direction, and the operation repeated for a part of the object that has not yet been imaged. In other words, an on-the-fly image is created having enhanced depth of focus while the object is scanned which enables saving a large amount of data. In FIG. 9 oblique section 5 is shown as only moving laterally in the x direction, however as well as moving the translation stage such that the oblique section moves laterally, the imaging lens 22 can be moved in the direction of the optical axis (in the down range direction) such that the oblique section moves both laterally and in the down range direction. In this manner the apparatus can follow large-scale deviations in down range positions of the object 4.

FIG. 10 shows schematically an object and a projection of a 2D detector array, and serves to help further explain an example of the apparatus and method for the generation of a synthetic 2D image with enhanced depth of field. Object 4, could for example be the ground over which a UAV with the apparatus is flying and imaging, or could be representative of features of an insect being imaged, where those features extend in the down range direction. A projection of the 2-D array of the detector is shown as section 5, which corresponds to the object where the sensor can actually detect an image. A Cartesian coordinate system X′, Y, Z is shown, where the detector has been tilted with respect to the X′ axis by an angle β′ of 30° . In an example, X′ and Y lie in the lateral (e.g. horizontal) plane and Z extends in a a down range (e.g. vertical) direction. In other words the detector lies in the X-Y plane, tilted out of the lateral (horizontal) plane, and in this example this creates the oblique projection of the detector at the object. It is to be understood, that these axes are described with respect to the schematic system as shown in FIG. 7, where the detector is in a direct line along the optical axis O, however the skilled person will appreciate that a mirror or mirrors could be utilized such that the detector in a vertical orientation as shown in FIG. 7 would not be tilted. Δxis X′ is in the lateral direction, which is the scan direction and which in this example is perpendicular to the optical axis O. As discussed, the apparatus could be utilized with a submersible remote operated vehicle (rov) in which case the object being imaged could be within a medium having a refractive index, or the object itself could be transparent and have a characteristic refractive index. Section 5 can therefore makes an angle β at the object that is different to the angle of tilt β′ of the detector (in a similar way to a stick half in and half out of water, appearing to bend at the interface between the air and water). The oblique cross section 5 intersects with object 4 at intersection I shown in FIG. 10, with intersection I then being in focus. As will be discussed in more detail with reference to FIG. 12, the detector is operated in a line scanning mode. In other words a row or a number of adjacent rows of pixels can be activated, where each row is at a lateral position x′ and extends into the page as shown in FIG. 10 along the Y axis. If object 4 was not angled in the Y direction, then intersection I would be at the same down range distance Z along the Y axis, and intersection I would be imaged in focus by the one or more activated rows. However, not only can intersection I vary in X′ and Y coordinates along its length, but different features to be imaged can be present in the Y axis of the object. Therefore, referring back to FIGS. 8 and 9, and how a working image is continuously generated, those diagrams can be considered to represent a slice through the object as shown in FIG. 10, at one Y coordinate. The process as explained with reference to FIGS. 8 and 9 is then carried out for all the slices at different Y coordinates. In other words, image data at each X′, Y position, but with different Z coordinates, acquired for different oblique sections 5 is continuously updated to have the best focused feature at that X′, Y position, where that update can either mean that the image in a just acquired image replaces the corresponding image in the working image if the new image data has a better focus, or if the working image has a better focus the working image remains as it is for the image at that X′, Y coordinate. Rather than operating with a detector in line scanning mode, a normal CCD detector can be utilized with appropriate parts of the image used, in a similar manner as described above, in generating and updating the working image for each lateral position of the object.

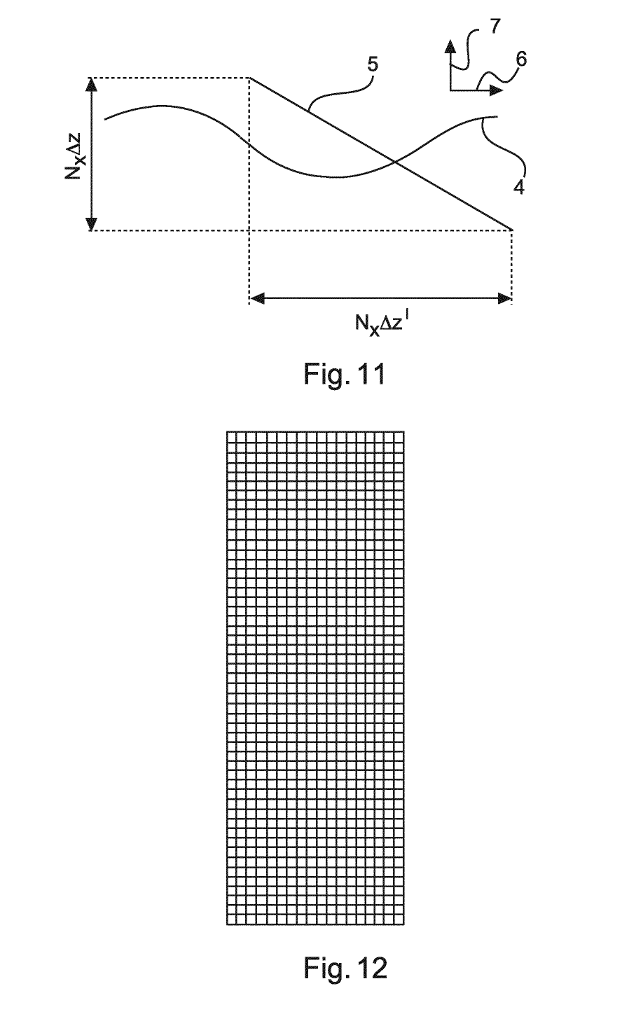

FIG. 11 shows schematically a cross section of an object 4, with a projection of a 2D detector array 5 shown and serves to help explain the apparatus setup. As seen from FIG. 11, the tilted detector makes an image of an oblique cross section 5 of the object. The tilt is in a scanning direction 6, in the lateral direction (X′). Along the X axis the detector has Nx pixels and samples the object in the scan (lateral) direction X′ with Δx′ per pixel and in the axial (vertical) direction 7 (Z) parallel to the optical axis O with Δz per pixel. In the X direction, each pixel has a length L. As discussed above, the detector is tilted by an angle β′, therefore the lateral and axial sampling at the object is given by:

$$Δ {x}^{′} = \frac{L cos {β}^{′}}{M}$$

$$Δ z = \frac{nL sin {β}^{′}}{{M}^{2}}$$

Where M is the magnification and n is the refractive index as described above.

FIG. 12 shows schematically an example 2D detector array, that acquires data used to generate the image with an enhanced depth of focus. The pixels shown in white are sensitive to light and can be used for signal acquisition if activated, with other pixels not shown being used for dark current and signal offsets. A number of pixels, not shown, represent the pixel electronics. A number of rows (or lines) of pixels form an individual line imaging detector, which with reference to FIG. 10 is at one X′, Z coordinate and extends into the page along the Y axis. A strip of pixels consisting of adjacent lines or pixels can be combined using time delay integration (TDI) into a single line of pixel values. Different numbers of lines can be combined in different example detectors, where for example, 2, 3, 4, 5, 10 or more adjacent lines of pixels can be combined using TDI. In effect, each strip of pixels can act as an individual TDI sensor, thereby improving signal-to-noise. For this detector, each line imaging detector has a length of several thousand pixels extending in the Y direction, which for example represents line I as shown in FIG. 10. For example, the length can be 1000, 2000, 3000, 4000, 5000 or other numbers of pixels. If a focus actuator is not used to move the imaging lens during lateral scan, then each line detector will image the object at a constant down range distance over the depth of focus of the apparatus. As discussed, each strip of pixels can represent a number of rows of a single TDI block if the TDI is activated. The detector contains a number of these blocks, separated by readout electronics. For, example the detector can contain 100, 200, or 300 blocks. The detector can have other numbers of blocks. Relating to cross-section 5, which is the projection of the detector in the object, the distance in the z direction between each TDI block can be varied depending upon the imaging situation. Therefore, over an intrinsic depth of focus of the apparatus there can be a number of TDI blocks distributed within this depth of focus. The detector can be configured such that the distance in the z direction between blocks can variable, and can vary between blocks. One of these TDI blocks, or indeed a number of these blocks within this depth of focus, can be used individually or summed together to provide image data at a particular down range position. Then, one or more TDI blocks at a different position of the detector, along the X axis, can be activated to acquire image data for a different down range distance of the object over a depth of focus. The second down range distance is separated from the first depth by at least the depth of focus. Each TDI block, or TDI blocks, over the depth of focus at a particular down range distance in effect sweeps out a layer of image data within the object, the layer having a thickness approximately equal to the intrinsic depth of focus of the image acquisition unit of the apparatus. Therefore, to acquire data for an object extending over a down range distance equal to eight times the intrinsic depth of focus of the apparatus, means that eight such TDI blocks, at different positions along the detector, each at a different down range distance and lateral position but having the same down range distance along its length, can be used to acquire the image data from the object. The features to be imaged can lie anywhere within this overall down range distance (for example the object could be a tree in winter and branches at the front, middle and back of the tree are to be imaged). Therefore, as cross-section 5 is swept laterally through the object, each of these eight TDI blocks will acquire image data at the same X′, Y coordinates of the object, but at different down range distances Z. It is therefore to be noted that active TDI blocks used to acquire data can be spaced from another active TDI block that is acquiring data by a number of TDI blocks that are not acquiring data. A first image comprising image data from these 8 TDI blocks is used to form a working image comprising image data for each X′, Y position imaged. When the cross-section 5 is moved laterally within the object, image data will be acquired for the majority of the X′, Y positions already imaged, but at a different down range distances for those X′, Y positions. As discussed with reference to FIGS. 8 and 9 the working image is updated such that it contains the best focus image at that X′, Y position acquired thus far. This can be done on the fly, without the need to save all the image data, rather a working image file is saved and compared with the image file just acquired and updated where necessary. A synthetic 2D image is thereby generated with an enhanced depth of field, where a feature at one down range distance in the object can be in focus and a different feature at a different down range distance in the object can also be in focus, where the difference is those down range distances is greater than the intrinsic depth of focus of the image acquisition unit such that it is not possible to have both in focus in a regular setup (which only acquires data at one down range distance over a depth of focus of the imaging system). In other words, multiple features can be in focus while these features change differently in down range distance within the object. Rather than selecting the working image file to be either new image data or maintaining the original working image data, a weighted sum of the new image data with the existing working image data can be used to provide an updated working image. Although the detector is working in a line imaging mode, it should be noted that individual sections along the line image are used separately. This is because, a particular feature at one point along the line image can be in focus whilst another feature, due to it being at different down range distance outside the depth of focus, at another point along the line image can be out of focus. Therefore, selection is made on a more local (pixel) level, where pixel can mean several pixels sufficient to make a comparison with the working image data to determine which data at that lateral position (specific X′, Y coordinate range) is in the best focus. Rather than being fixed relative to one another, the TDI blocks used to acquire data can move up and down the detector, and also move relative to one another. The spacing between the TDI blocks used to acquire data can remain the same as the TDI blocks move, or the spacing between the TDI blocks can vary as a TDI blocks move, with the spacing between adjacent TDI blocks varying differently for different TDI blocks. This provides the ability to scan an object at different resolution levels, and to have different resolution levels throughout the object. For example, across an object, features to be images could be predominantly either at a small down range distance (close to the apparatus) or at a large down range distance (far from the apparatus), with few features of interest at intermediate down range distances. Then, a number of TDI blocks could be arranged to scan the object over these two sets of down range distances and not to scan the object over intermediate down range distances.

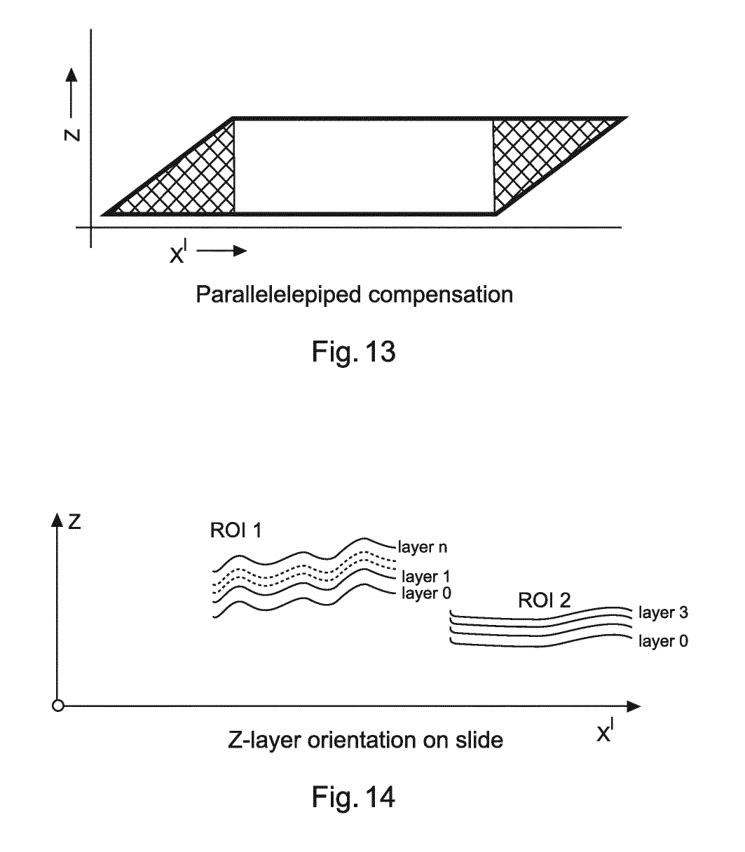

FIG. 13 shows schematically an example of oversampling, where an image with enhanced depth of field is to be acquired for the central clear region. From the discussion relating to the previous figures, it is clear that image data at all available down range distances for a particular lateral point of the object is generated once the projection of the detector at the object, i.e. cross-section 5, has completely scanned past that point. In other words, the first part of the detector acquires image data at one extreme down range distance and when the object has been moved sufficiently (and/or the apparatus scanned), the last part of the detector will then acquire image data at the other extreme down range distance. Intermediate parts of the detector will acquire image data at intermediate down range distances. However, this means that to scan a particular region over all available down range distacnes the projection of the detector must start just off to one side of the region to be scanned and finish just off the other side of the region to be scanned, as shown in FIG. 13. In other words, there is a certain amount of oversampling at either end of a region to be scanned. With respect to the discussion relating to FIG. 11, it can then easily be determined what such oversampling is required to be.

FIG. 14 shows schematically a number of imaged regions or layers. In other words, each layer corresponds to what each TDI block (or blocks) images at a particular down range distance over the intrinsic depth of focus of the apparatus. As previously discussed, the object may vary considerably in down range distance. Therefore, prior to acquiring imagery to be used in generating a synthetic 2-D image with an enhanced depth of field of an object, a relatively low resolution image of the object can be obtained. This is used to estimate the z-position (down range distance) of the object volume. In other words, at one or more locations (X′, Y) the optimal focus (Z) is determined. Then, during acquisition of the imagery that generates a synthetic 2-D image with enhanced depth of field in a streaming mode, at each position the imaging lens is moved appropriately along the optical axis O (or object moved along the optical axis) and multiple TDIs are activated for acquisition of the data discussed above. In an example, rather than changing the position of the section 5 through movement of the imaging lens or translation stage, the positions of the TDIs are moved up and down the detector as required. In this case the section 5 can scan over a constant range of down range distances, but different parts of the detector can acquire data. Alternatively, rather than obtaining a prior low resolution image a self focusing (autofocusing) sensor can be utilised as described for example in WO2011/161594A1. In such autofocusing configuration, the detector as shown in FIG. 12 can itself be configured as autofocusing sensor, or a separate autofocusing sensor can be utilised. This means that every position that image data is being acquired for generation of the image of enhanced depth of focus, the position of the object can be determined and TDIs activated as required. The result is shown in FIG. 14 which indicates the down range distances of the object being imaged by separate TDIs during the scan. As discussed, at each lateral position the enhanced image will be generated such that a feature at a particular down range distance is present in the synthetic enhanced image, where features at different down range distances (and hence in different layers) are then present in the resultant enhanced image. As discussed above, the enhanced image is generated without all of the separate images having to be saved, rather only a working image is saved and compared to the image just acquired thereby enabling an image with enhanced depth of field to be generated on the fly, without a large image buffer being required.

In this manner, the system can generate an image on the fly that can have multiple features of an object in focus, while those features are at different down range distances

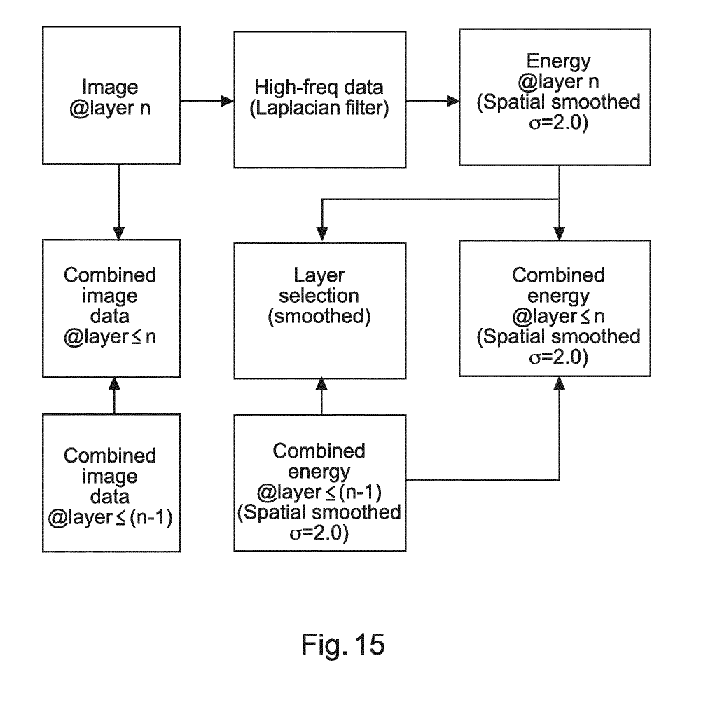

Focus stacking was briefly introduced with reference to FIG. 5. In FIG. 15 an example workflow for focus staking used in generating a synthetic image with enhanced depth of field is shown. For ease of explanation, focus stacking is described with respect to a system acquiring data as shown in FIG. 8, however it has applicability for a tilted detector that provides an oblique cross section. In the discussion that follows, a layer, as discussed previously, relates to what the image acquisition unit is imaging at a particular down range distance of an object over a depth of focus at that down range distance. Here, because the explanation relates to a non-tilted detector the layer is at the same down range distance within the object, but as discussed this focus stacking process equally applies to a tilted detector and oblique cross section over which data is acquired. Therefore, the image of layer n is acquired. Firstly, the amount of energy of the input image, acquired at z-position n, is determined. The amount of energy is determined by applying a high-pass filter (i.e. a Laplacian filter), followed by a smoothing operation (to reduce the amount of noise). Secondly, this calculated amount of energy of layer n is compared with the energy of layer ≤(n−1). For every individual pixel, it is determined if the current layer (i.e. image data of layer n), or the combined result (i.e. combined image data of layer ≤(n−1)—the working image as discussed previously) should be used; the result of this is the “Layer selection” of FIG. 15. Thirdly, two buffers have to be stored, namely the combined image data (i.e. image data of layer ≤n) and the combined energy data (i.e. of layer ≤n). Then, the next layer can be scanned, and the process repeats, until the last layer has been acquired and processed. It is to be noted that layer selection (i.e. which part you select from which layer) is used to combine the information from the image data of layer n and the image data of combined image ≤(n−1), as well as for the energy.

Therefore, in an example a tilted sensor is combined with focus stacking, in streaming mode. Then, it is no longer needed to store the intermediate results completely (i.e. image data of layer ≤(n−1) and energy of layer ≤(n−1)), but only a limited history of the image and energy data is needed, determined by the footprint of the used image filters (i.e. high-pass filter and smoothing filter). Each time a new (slanted) image is acquired by the slanted sensor, the energy per row (i.e. per z-position) of this image is determined; the slanted image, as discussed previously, is in a plane in Y (rows of the image) and X′/Z (columns of the image). These energy values are compared with the previous acquisitions. The comparison is performed for matching (x′,y) positions, in other words at a local level (enough pixels for which the above energy analysis can be applied) and not for the whole line image as one image. If more focus energy is found, the image data is updated. Once all z-positions of a (x′,y) position have been evaluated, the (combined−“working”) image data can be transferred. This removes the need to store tens of GBs of intermediate results, while the final result (i.e. the enhanced depth of focus layer) is (still) available directly after scanning the last part of the object.

Alternatives In the above process, for every pixel the optimal image layer is determined by the amount of energy (i.e. a high-pass filter). A possible implementation is that the different colour channels are merged (i.e. using a RGB2Y operation), before determining the high frequency information. As an alternative, information (i.e. from an external source or determined by image analysis) can be used to focus more on a specific colour. This can even be combined with an extra colour separation step or colour deconvolution step. Then, the optimal layer can locally be determined by the amount of energy using one (or multiple) specific colour (e.g. focussing on a particular colour in the image). Furthermore, adding a colour separation step can result in the use of different 2D smoothing kernels. For example, features of an object can have varying sizes with those which contain much smaller details benefits from smaller smoothing kernels (σ<2).

In the above process a Laplacian high-frequency filter is used. As an alternative, the acquired data can be translated to the wavelet domain, where the high frequency sub band can be used as a representation of the energy. This can be combined with the iSyntax compression (see for example U.S. Pat. No. 6,711,297B1 and U.S. Pat. No. 6,553,141).

In the above process, the conversion to a single image layer having enhanced depth of field can be applied before sending the image to the server. It is also possible that the conversion to a single layer is performed on the server, such that output of the sensor is directly transferred to the server.

Instead of selecting the optimal layer for every pixel, it is also possible that the pixel values of multiple layers are combined using a particular weighting, based on the distribution of the energy of the pixels.

Instead of selecting the optimal layer for every pixel, it is also possible to sum all pixels of the tilted sensor of the same z-direction. The result is a blurred sum images which can subsequently be filtered with a simple band filter. For information relating to the summing of digital pictures see U.S. Pat. No. 4,141,032A.

This method can also be used to measure the thickness of the object, as this is related to the energy of each layer.

In another exemplary embodiment, a computer program or computer program element is provided that is characterized by being configured to execute the method steps of the method according to one of the preceding embodiments, on an appropriate system.

The computer program element might therefore be stored on a computer unit, which might also be part of an embodiment. This computing unit may be configured to perform or induce performing of the steps of the method described above. Moreover, it may be configured to operate the components of the above described apparatus. The computing unit can be configured to operate automatically and/or to execute the orders of a user. A computer program may be loaded into a working memory of a data processor. The data processor may thus be equipped to carry out the method according to one of the preceding embodiments.

This exemplary embodiment of the invention covers both, a computer program that right from the beginning uses the invention and computer program that by means of an update turns an existing program into a program that uses the invention.

Further on, the computer program element might be able to provide all necessary steps to fulfill the procedure of an exemplary embodiment of the method as described above.

According to a further exemplary embodiment of the present invention, a computer readable medium, such as a CD-ROM, is presented wherein the computer readable medium has a computer program element stored on it which computer program element is described by the preceding section.

A computer program may be stored and/or distributed on a suitable medium, such as an optical storage medium or a solid state medium supplied together with or as part of other hardware, but may also be distributed in other forms, such as via the internet or other wired or wireless telecommunication systems.

However, the computer program may also be presented over a network like the World Wide Web and can be downloaded into the working memory of a data processor from such a network. According to a further exemplary embodiment of the present invention, a medium for making a computer program element available for downloading is provided, which computer program element is arranged to perform a method according to one of the previously described embodiments of the invention.

It has to be noted that embodiments of the invention are described with reference to different subject matters. In particular, some embodiments are described with reference to method type claims whereas other embodiments are described with reference to the device type claims. However, a person skilled in the art will gather from the above and the following description that, unless otherwise notified, in addition to any combination of features belonging to one type of subject matter also any combination between features relating to different subject matters is considered to be disclosed with this application. However, all features can be combined providing synergetic effects that are more than the simple summation of the features.

While the invention has been illustrated and described in detail in the drawings and foregoing description, such illustration and description are to be considered illustrative or exemplary and not restrictive. The invention is not limited to the disclosed embodiments. Other variations to the disclosed embodiments can be understood and effected by those skilled in the art in practicing a claimed invention, from a study of the drawings, the disclosure, and the dependent claims.

In the claims, the word “comprising” does not exclude other elements or steps, and the indefinite article “a” or “an” does not exclude a plurality. A single processor or other unit may fulfill the functions of several items re-cited in the claims. The mere fact that certain measures are re-cited in mutually different dependent claims does not indicate that a combination of these measures cannot be used to advantage. Any reference signs in the claims should not be construed as limiting the scope.

1. An apparatus for generating a synthetic 2D image with an enhanced depth of field of an object, the apparatus comprising:
an image acquisition unit; and
a processing unit;
wherein the image acquisition unit is configured to acquire first image data at a first lateral position of the object and second image data at a second lateral position of the object;
wherein the image acquisition unit is configured to acquire third image data at the first lateral position and fourth image data at the second lateral position, wherein the third image data is acquired at a down range distance that is different than that for the first image data and the fourth image data is acquired at a down range distance that is different than that for the second image data;
wherein the down range distance is a distance from the apparatus of a specific part of the apparatus;
wherein the processing unit is configured to generate first working image data for the first lateral position, the generation comprising processing the first image data and the third image data by a focus stacking algorithm, and the processing unit is configured to generate second working image data for the second lateral position, the generation comprising processing the second image data and the fourth image data by the focus stacking algorithm to generate second working image data for the second lateral position; and
wherein the processing unit is configured to combine the first working image data and the second working image data, during acquisition of image data, to generate the synthetic 2D image with an enhanced depth of field of the object.

2. Apparatus according to claim 1, wherein the image acquisition unit comprises a detector configured to acquire image data of an oblique section of the object.

3. Apparatus according to claim 2, wherein the detector is a 2D detector comprising at least two active regions.

4. Apparatus according to claim 1, wherein the image acquisition unit is configured to acquire image data of a first section of the object to acquire the first image data and the second image data, and wherein the image acquisition unit is configured to acquire image data of a second section of the object to acquire the third image data and the fourth image data.

5. Apparatus according to claim 1, wherein the image acquisition unit is configured to acquire the first image data at the first lateral position of the object and at a first down range distance and to simultaneously acquire the second image at the second lateral position of the object and at a second down range distance, wherein the first down range distance is different to the second down range distance; and wherein the image acquisition unit is configured to acquire the third image data at the first lateral position and at a third down range distance and to simultaneously acquire the fourth image data at the second lateral position and at a fourth down range distance, wherein the third down range distance is different to the fourth down range distance.

6. Apparatus according to claim 1, wherein the image acquisition unit has a depth of focus at the first lateral position and at the second lateral position neither of which is greater than a distance in down range distance between the down range distance at which the first image data is acquired and the down range distance at which the second image data is acquired.

7. Apparatus according to claim 1, wherein the object is at a first position relative to an optical axis of the image acquisition unit for acquisition of the first image data and second image data and the object is at a second position relative to the optical axis for acquisition of the third image data and fourth image data.

8. Apparatus according to claim 1, wherein the image data comprises a plurality of colours, and wherein the processing unit is configured to process image data by the focus stacking algorithm on the basis of image data that comprises one or more of the plurality of colours.

9. A method for generating a synthetic 2D image with an enhanced depth of field of an object comprising:
a) acquiring with an image acquisition unit first image data at a first lateral position of the object and acquiring with the image acquisition unit second image data at a second lateral position of the object; wherein the image acquisition unit comprises a detector configured to acquire image data of an oblique section of the object;
b) acquiring with the image acquisition unit third image data at the first lateral position and acquiring with the image acquisition unit fourth image data at the second lateral position, wherein the third image data is acquired at a down range distance that is different than that for the first image data and the fourth image data is acquired at a down range distance that is different than that for the second image data, wherein the down range distance is a distance from an apparatus comprising the image acquisition unit or a specific part of the apparatus;
e) generating first working image data for the first lateral position, the generation comprising processing the first image data and the third image data by a focus stacking algorithm; and
f) generating second working image data for the second lateral position, the generation comprising processing the second image data and the fourth image data by the focus stacking algorithm; and
l) combining the first working image data and the second working image data, during acquisition of image data, to generate the synthetic 2D image with an enhanced depth of field of the object.

10. Method according to claim 9, wherein step a) comprises acquiring the first image data at the first lateral position of the object and at a first down range distance and simultaneously acquiring the second image at the second lateral position of the object and at a second down range distance, wherein the first down range distance is different to the second down range distance; and wherein step b) comprises acquiring the third image data at the first lateral position and at a third down range distance and simultaneously acquiring the fourth image data at the second lateral position and at a fourth down range distance, wherein the third down range distance is different to the fourth down range distance.

11. Method according to claim 9, wherein the method comprises:
c) calculating a first energy data for the first image data and calculating a third energy data for the third image data; and
d) calculating a second energy data for the second image data and calculating a fourth energy data for the fourth image data; and
wherein, step e) comprises selecting either the first image data or the third image data as the first working image, the selecting comprising a function of the first energy data and third energy data; and
wherein step f) comprises selecting either the second image data or the fourth image data as the second working image, the selecting comprising a function of the second energy data and fourth energy data; and
wherein frequency information in image data is representative of energy data.

12. Method according the claim 11, wherein the method comprises:
g) generating a first working energy data as the first energy data if the first image data is selected as the first working image or generating the first working energy data as the third energy data if the third image data is selected as the first working image; and
h) generating a second working energy data as the second energy data if the second image data is selected as the second working image or generating the second working energy data as the fourth energy data if the fourth image data is selected as the second working image is the fourth image data.

13. Method according to claim 9, wherein the method further comprises:
i) acquiring fifth image data at the first lateral position and acquiring (230) sixth image data at the second lateral position, wherein the fifth image data is acquired at a down range distance that is different than that for the first and third image data and the sixth image data is acquired at a down range distance that is different than that for the second and fourth image data; and
j) generating new first working image data for the first lateral position, the generation comprising processing the fifth image data and the first working image data by the focus stacking algorithm, wherein the new first working image data becomes the first working image data; and
k) generating new second working image data for the second lateral position, the generation comprising processing the sixth image data and the second working image data by the focus stacking algorithm, wherein the new second working image data becomes the second working image data.

14. A computer program element for controlling an apparatus according to claim 1, which when executed by a processor is configured to carry out the method of claim 9.

15. A computer readable medium having stored the program element of claim 14.
